(19) United States
(12) Patent Application Publication
(10) Pub. No.: US 2016/0170739 A1
(43) Pub. Date: Jun. 16, 2016

(54) ALTER APPLICATION BEHAVIOUR DURING RUNTIME

(71) Applicants: DIMITAR KAPASHIKOV, SOFIA (BG); GEORGI GEORGIEV, SOFIA (BG)

(72) Inventors: DIMITAR KAPASHIKOV, SOFIA (BG); GEORGI GEORGIEV, SOFIA (BG)

(21) Appl. No.: 14/569,831

(22) Filed: Dec. 15, 2014

(51) Int. Cl. G06F 9/445; G06F 9/44

(52) U.S. Cl. CPC G06F 8/67; G06F 8/70

(57) ABSTRACT

Various embodiments of systems and methods to alter application behavior during runtime are described herein. In one aspect, a provided modified application component is read from a resource provider. In another aspect, an original application component corresponding to the modified application component is identified uploaded in a system runtime environment by one or more applications. In yet another aspect, the modified application component is submitted to the runtime environment to handle next invocation of the application component during the execution of at least one of the one or more applications.

### BACKGROUND

The development and maintenance of software applications involve changing parts of their program code to alter their behavior. Such changes could be motivated by customer requests, desire to enhance or improve particular functionalities, or to fix identified problems, e.g., bugs, security holes, etc. When a change in the behavior of a software application is required or desired, the common practice is to modify the involved software component or components, and to use them to reinstall the application. This practice is followed regardless how big the change is, or how often the affected component or components have to be modified to achieve the desired behavior of the software application. Reinstalling an application could be a cumbersome task, especially in enterprise environments supporting critical business processes, or in complex development projects built by numerous stakeholders.

### BRIEF DESCRIPTION OF THE DRAWINGS

The claims set forth the scope with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a computing system environment to alter a behavior of software components during runtime, according to one embodiment.

FIG. 2 is a flow diagram illustrating a process to alter application behavior during runtime, according to one embodiment.

FIG. 3 is a flow diagram illustrating a process to revert, during runtime, altered application behavior, according to one embodiment.

FIG. 4 is a block diagram illustrating a computing system environment to alter a behavior of software components during runtime, according to one embodiment.

FIG. 5 is a block diagram illustrating a computing system environment to alter a behavior of software components during runtime, according to one embodiment.

FIG. 6 is a block diagram of an exemplary computer system, according to one embodiment.

### DETAILED DESCRIPTION

Embodiments of techniques to alter application behavior during runtime are described herein. In the following description, numerous specific details are set forth to provide a thorough understanding of the embodiments. One skilled in the relevant art will recognize, however, that the presented ideas can be practiced without one or more of the specific details, or with other methods, components, materials, etc. In other instances, well-known structures, materials, or operations are not shown or described in detail to avoid obscuring.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

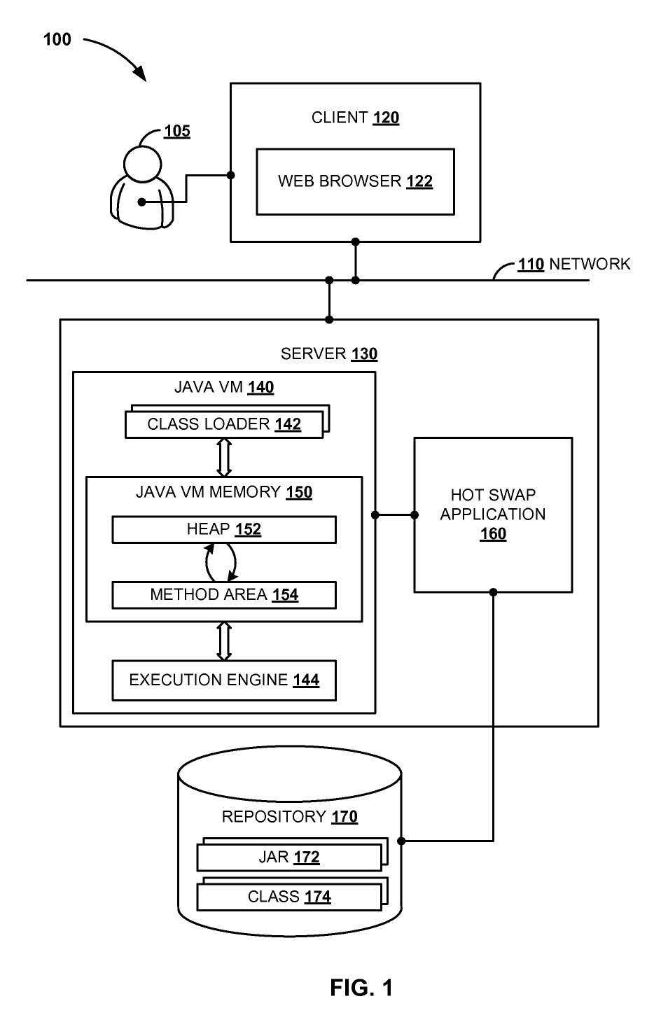

FIG. 1 is a block diagram illustrating computing system environment 100 where hot swap application 160 is implemented to alter application behavior, according to one embodiment. One of the advantages of the hot swap application 160 is that it allows changing the behavior of the software applications executed on server 130 during runtime. In other words, the behavior of a running application could be altered without reinstallation. As illustrated in the figure, server 130 is hosting Java® runtime environment or Java® Virtual Machine (VM) 140. The Java VM 140 provides execution or runtime environment for various software applications, according to one embodiment. Alternatively, software technologies other than Java could be used for providing runtime environments on different computer systems.

Some of the main modules of the Java VM 140 as illustrated include Java VM memory 150 to store the executable instructions of the installed software applications; execution engine 144 to process the instructions from the memory, and one or more class loaders 142 to upload or install the software components of the applications in the Java VM memory 140. Class loaders (e.g., of class loaders 142) could be user defined. Typically, the software components of the applications are classes and interfaces, which are loaded in the Java VM 140 by the corresponding class loaders 142, linked, initialized and executed. In one embodiment, different class loaders are assigned to different applications. For every application to be executed at server 130, the Java VM 140 may raise a separate class loader (e.g., class loaders 142) that is responsible for loading the resources of this application, including the classes, and other files (e.g., interfaces, libraries, etc.).

It is not unusual that different applications share same software components, e.g., classes. Therefore, when a same class is used by more applications, the class could be uploaded by more than one class loader. Usually, a Java class is uniquely identified by the name of the package where it resides. That could also be determined by the software vendor providing the application server (e.g., server 130) and the applications executed on it. For example, the name of a class as used in application packages provided by SAP SE may be formed based on the following template:
“com.sap<name of appliaction><name of the class>”
   However, in some applications one and the same package and name may exist in more than one application.

In one embodiment, the application resources to be uploaded in the Java VM 140 are stored in repository 170. For example, the classes could be included in Java Archive files (JAR) 172, where a JAR file may provide an installation package including the necessary resources for one or more applications. Additionally, software components may be provided separately, e.g., as “*.class” files (e.g., classes 174).

In one embodiment, the hot swap application 160 is a separate application running on server 130, providing functionality to alter the behavior of other applications during their execution. For example, the hot swap application 160 may be also uploaded on the Java VM 140, similarly to the other application, e.g. the instructions uploaded in Java VM memory 150 and executed by execution engine 144 of the Java VM 140. A stakeholder (e.g., in a development project) or an administrator (e.g., of a business computing environment) could modify one or more software components (e.g., classes) and provide them for upload (e.g., stored in repository 170), and use the hot swap application 160 to switch or redefine the previously loaded instructions of the one or more software components to the modified state. For example, the modified instructions could be uploaded in heap 152, which is the dynamically allocated part of Java VM memory 150 for keeping uploaded objects. From there, the instructions could be provided to method area 154 for execution, replacing the previous instructions associated with the one or more software components.

In one embodiment, the alteration of the functionality of an uploaded application is instrumented directly at virtual machine level on which the class and the application is executed, instead of at source code level, Thus, no re-installation of the running applications to implement the new code is required. In one embodiment, the virtual machine may provide functionality to replace an existing software component, e.g., Java class, with a new one. The new (e.g., modified) class may be uploaded to change the original one with the help of the hot swap application (160) by calling methods provided by an instrumentation interface of the virtual machine (e.g., Java VM 140). The instructions for every uploaded software component are stored at the VM, and the VM may provide an application programming interface (API) that could be used to change the already uploaded original instructions with the modified instructions provided with the modified program components.

The installation and operation of the hot swap application 160 could be managed by users (e.g., user 105) at client 120, e.g., through web browser 122 via network 110 (e.g., public or private computer network). In one embodiment, the user 105 could receive a list of modified software components, e.g., in a UI provided by the web browser 122. The user could also receive a list of applications loaded at the Java VM 140, which include one or more of the listed modified components. Both lists could be extracted by the hot swap application 160, e.g., from repository 170 and from Java VM memory 150, respectively. In one embodiment, the hot swap application 160 may scan and match the repository 170, including JAR 172 and class 174 files, and the Java VM memory 150, to generate the two lists or a single list with the corresponding components. Such scanning could be triggered by starting the hot swap application 160, or/and in response to user request or other event.

In one embodiment, the hot swap application 160 could keep the original state of the altered functionality of the modified software components, either locally on server 130 or in repository 170, or both. Thus, when requested, e.g., by user 105 via a UI at the web browser 122, the hot swap application 160 may revert the state in the Java VM memory 150. The reverting may be applied to entire set of functionality of the one or more modified software components, or partially, e.g., to selected methods or functions.

Although presented as client-server architecture, the illustrated computing environment modules could be distributed differently. For example, the user 105 may access the hot swap application 160 directly, e.g., at server 130. Thus, server 130 may be just a standalone computer system, not servicing external clients. In addition, the functionality described in reference to storage 170 could be provided internally, e.g., by the file system of server 160.

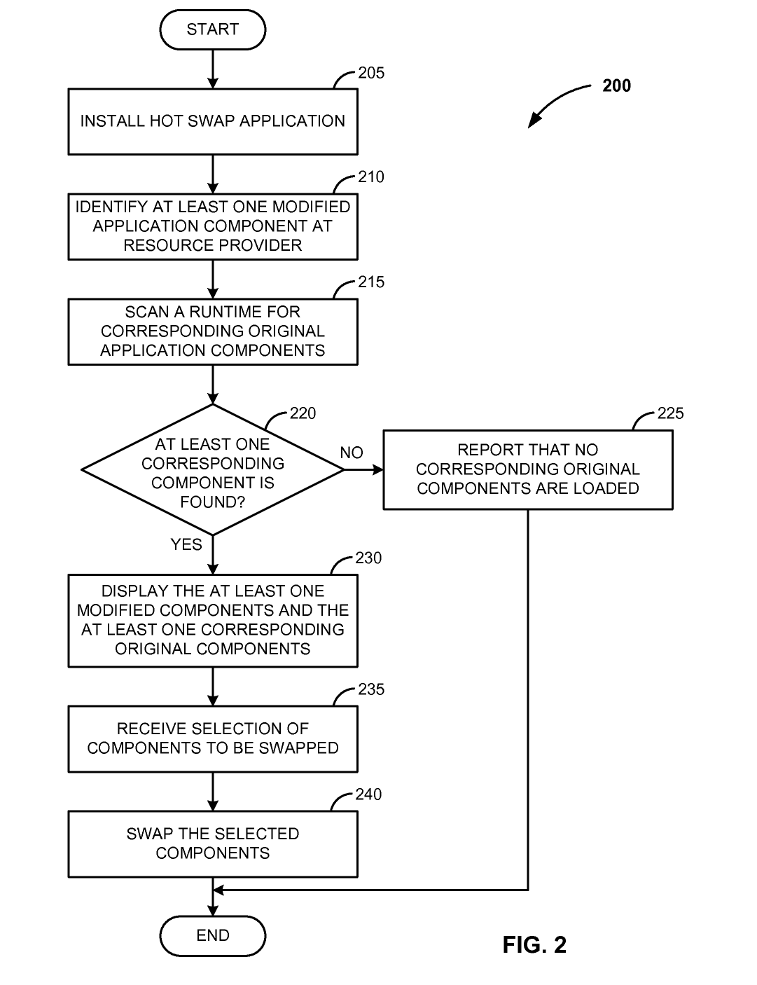

FIG. 2 illustrates process 200 to alter the behavior of one or more applications during runtime, according to various embodiments. At 205, an application (so called hot swap application) to alter the behavior of one or more other applications is installed. The hot swap application could be installed at the runtime environment where the one or more other applications are executed. Alternatively, the hot swap application could be installed on a different environment and/or system, and accessing the runtime environment of the other one or more applications via appropriate interfaces and/or middleware.

At 210, the hot swap application identifies at least one modified software component used by the one or more applications, where the modification of the at least one component alters the behavior of the one or more applications. The at least one modified component could be identified at one or more resource providers. In this case, a resource provider could be regarded as physical resource storage, e.g., a repository. The at least one modified component could be provided as one or more separate resource files with source code (e.g., Java class files), or prepackaged in more complex installation bundle (e.g., one or more JAR files). According to one embodiment, the hot swap java application provides functionality enabling the identification of the at least one modified components based on user input and/or based on scanning the available resource providers. The hot swap application may compare metadata (e.g., file attributes, properties, etc.) to verify that a software component of an application has been modified after being uploaded.

Process 200 continues at 215, where the hot swap application scans the runtime environment where the one or more applications are uploaded, for original software components corresponding to the at least one modified software components. For example, the original components may be searched in the heap memory area of a Java VM runtime environment. At 220, a check may be performed to verify whether at least one uploaded original component corresponding to the at least one modified component is found at the runtime environment. If no such original components are found, it could be reported that no original components corresponding to the at least one modified component are loaded, at 225.

Alternatively, when at least one uploaded original component corresponding to the at least one modified component is located, the hot swap application may render the corresponding components to a display, e.g., via a browser UI (at 230). Since the same component could be uploaded for different applications, a list of the applications using the uploaded original component or components corresponding to the at least one modified components. Thus, a user may have an option to select the behavior of which particular application or applications, and which particular software component from the list to be altered. At 235, such a selection of component or components to be swapped for one or more running applications is received, e.g., at the hot swap application.

The swap or exchange of the functionality between the originally loaded software component or components with the functionality of the modified component or components is performed at 240. In one embodiment, the hot swap application may call corresponding methods of an instrumenting API provided by or at the runtime environment.

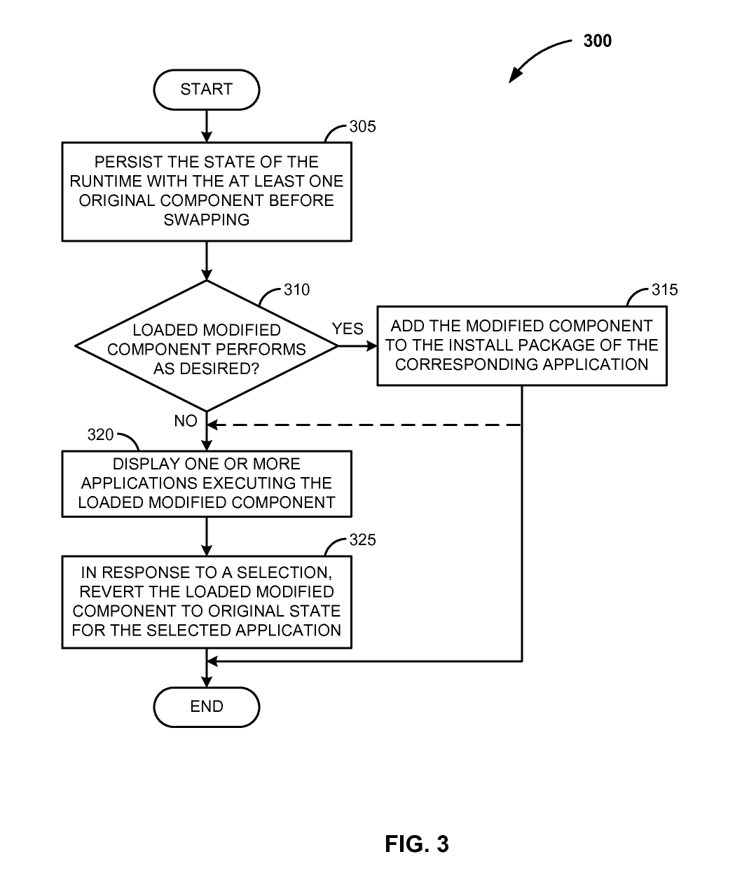

FIG. 3 illustrates process 300 to revert, during runtime, an altered behavior of one or more applications to the original one. From a certain perspective, process 300 may be regarded as a continuation of process 200 illustrated in FIG. 2. Process 300 starts at 305 with persisting the state the runtime originally had before the swapping. In one embodiment, the state is persisted by the hot swap application. Depending on the implementation, this step of process 300 could be executed before, simultaneously or after the swapping. The state could be stored locally, e.g., on the computer executing the runtime environment, or remotely, e.g., at a storage. Alternatively, instead of persisting or saving the state of the runtime, the hot swap application may locate the original source code of the program components that have been modified.

At 310, a check is performed whether a loaded modified component or components perform as desired. If this is the case, at 315 the modified component or components could be added to an install package, such as, a patch, a next version, etc., of the application or applications which behavior have been altered during runtime with the modification. This step of process 300 guarantees that the modification will be applied irreversibly with the next installation of the application, as well as it could be distributed, e.g., to one or more customers. For example, the modifications could be made in testing environment, to avoid any security breach or business critical malfunctions of a production system. Once the testing proves successful, the modification could be applied to the production systems in a standard and protected way.

When the modification is not achieving the expected or desired results, or if the behavior of the application or applications had to be altered temporarily (e.g., adding additional traces for better debugging), process 300 continues with reverting the modifications, either partially or completely. For example, at 320, the hot swap application may render the one or more applications with altered behavior and the corresponding modified component or components to a display, e.g., via a browser. Thus, a user may select the modification of which component and in which application to be reverted to its original state. At 325 in response to such a selection, or based on another event or a predefined algorithm, the runtime the state for the selected one or more application is partially or fully reverted to its original state during runtime, e.g., by swapping the uploaded modified instructions with their persisted original version. In one embodiment, the altered behavior of the one or more applications could be reverted to its original state, even when the modification is successful, as shown with the dashed arrow in FIG. 3. For example, if the alteration was temporarily required, it was used for proof of concept purpose, etc.

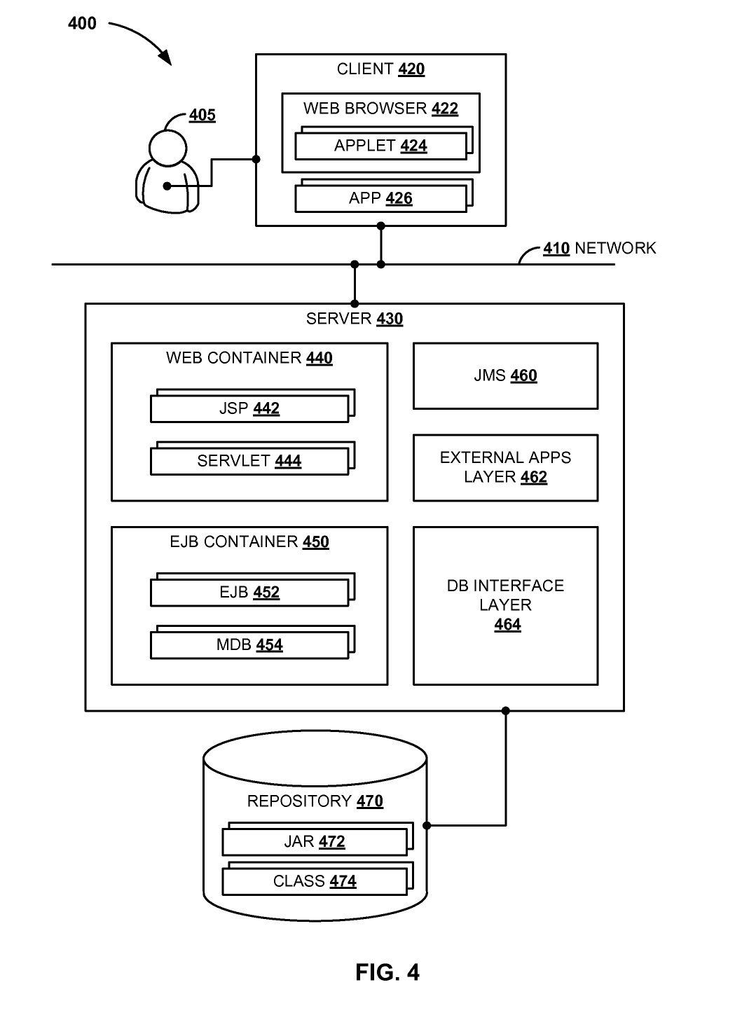

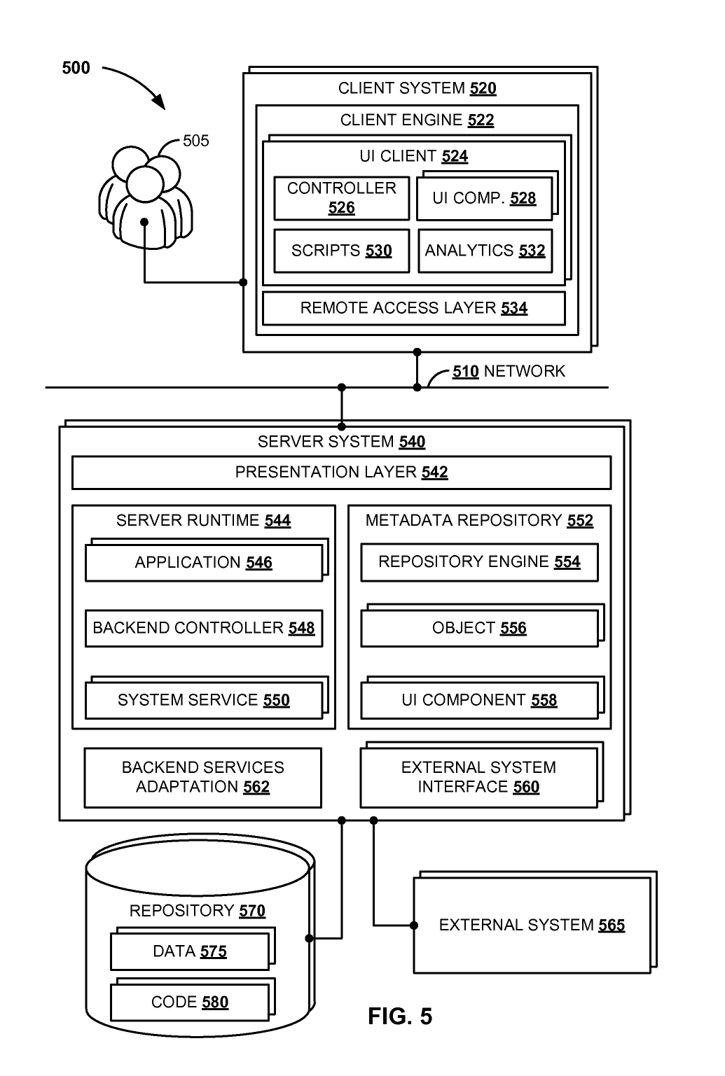

Processes 200 and 300 illustrated in FIG. 2 and FIG. 3, accordingly, could be matched to the system modules of the computing system environment 100 as shown in FIG. 1. However, other embodiments implementing the process 200 and 300 are also possible. For example, similar solution could be provided in computing environments based on technologies other than Java. FIG. 4 and FIG. 5 show computing environments built around computing systems based on different technologies, Java and non-Java, accordingly.

FIG. 4 shows Java-based computing system environment 400, according to one embodiment. As illustrated, user 405 operates on client 420 to access different services provided at server 430. In one embodiment, client 420 may run web browser 422 to provide the necessary interface for accessing server 430. In addition or as an alternative, various client applications 426 could be installed and executed at client 420 to handle the interaction with the services at server 430. The communication between client 420 and server 430 systems could be routed via network 410. In one embodiment, the communication between the client 420 and the server 430 is based on HyperText Transfer Protocol (HTTP), but other solutions are also possible.

As illustrated, server 430 is Java Application Server (Java AS®), e.g., built according to Java Enterprise Edition (Java EE®) specification. In one embodiment, the server 430 may provide an enhancement of the Java EE specification, e.g., vendor specific enhancement providing additional proprietary functionalities. However, for the purpose of the description, only Java EE specified modules are illustrated in FIG. 4. The runtime environments on both client 420 and server 430 systems could be provided by Java VMs. The Java VMs could be regarded as an extension or addition to the operating systems of these computer systems. Upon the Java VM infrastructure, the client system 420 and the server system 430 structures are defined by respective modules and services.

The client system 420 may include web browser 422 executing JavaScript® code (not shown), or providing in-browser Java VM environment to run Applets 424. The user may use an UI provided by the browser 422, e.g., by the JavaScript and/or the applets 424, to request and access services at server system 430. Alternatively, or in addition, one or more client-side applications, e.g., apps 426 could run on the client system 420 to allow the user 405 access the server 430. Apps 426 may be Java based, e.g., executed on Java VM running at the client 420. However, client applications built on other technologies could also provide the functionality to access the services at the server system 430.

The services at server 430 may be provided by one or more applications, e.g., executed in so called containers. The Java EE containers are system services that could be defined as runtime environments where various applications are executed. There are different types of containers for different types of software components. In FIG. 4 are illustrated Web container 440 and Enterprise JavaBean (EJB) container 450. In the Web container 440 are executed Java Server Page program components 442 and/or servlets 444. In the EJB container 450 are executed different types of JavaBeans, including Enterprise JavaBean (EJB) 452 and message-driven bean (MDB) 454 software components. The JSPs 442, servlets 444, EJBs 452 and MDBs 454 are different types of programming objects. The programming objects may represent different Java classes, corresponding to applications executed at the server 430.

In one embodiment, the illustrated elements of server 430 are built by system or application specific Java classes, e.g., executed on a Java VM implemented at the server 430. Besides the containers 440 and 450, the server 430 elements or modules may also include Java Messaging Service (JMS) 460 for sending messages between two or more clients, external applications layer 462 providing access to applications executed on different systems, database (DB) interface layer 464 providing access to external storage systems (e.g., repository 470), where business data, as well as the source code of the different program components may be stored (e.g., JARs 472 and classes 474). In one embodiment, the behavior of the application program components executed at the server 430 could be altered by an internal application, e.g., deployed in at least one of the containers (Web container 440, e.g., as a servlet, and/or EJB container 450, e.g., as an MDB). In one embodiment, the behavior of the different program components may be altered by an external application, e.g., via the external applications layer 462 and/or the JMS 460 infrastructure.

FIG. 5 is a block diagram showing computer system landscape 500 where application behavior is altered during runtime, according to one embodiment. The computer system landscape 500 includes a rather simplified example of classic client-server architecture, not necessarily built on Java technology. One or more shareholders or users 505, e.g., software product designers, developers, quality assurance (QA) specialists, end users, managers, etc., operate on one or more client systems 520. Users 505 may request different services or execute various operations available within client systems 520, or provided by one or more server systems 540 via network 510. The illustrated server systems 540 represent one or more backend nodes in the computer system landscape 500.

The client systems 520 and the server system nodes 540 communicating via network 510 may define a number of different computer system environments. The involved client systems 520 may have similar or different structures where one or more of the illustrated modules are replicated. One or more users 505 may operate within one or more instances of user interface (UI) client 524 of one or more of client systems 520. Different users 505 may exclusively access different instances of the UI client 524 within a same client system 520.

In one embodiment, any of client systems 520 may execute a standalone client application, e.g., client engine 522, to interact with the backend server system 540. Alternatively, an intermediate layer may be downloaded to any of the client systems 520 as an extension of a running Internet browser. Such intermediate layer may be also illustrated as client engine 522. The standalone client application and the intermediate layer may have similar components and functionality. Client engine 522 takes responsibility for rendering the necessary client functionality, and also for communicating with server systems 540 via network 510.

The client engine 522 includes UI client instances or sessions 524 that may also embed into a browser integrated framework. The UI client 524 may be a part of any popular browser integrated framework, e.g. Silverlight® provided by Microsoft Corp, Flex® provided by Adobe Systems Inc., JavaFX® originally developed by Sun Microsystems Inc., etc. In one embodiment, the client engine 522 and UI client 524, respectively, may be desktop application, for example, a .NET® application rendering a UI through a Windows Prosecution Foundation (WPF) system. The UI client 524 accesses the necessary business data at the backend 540 through remote access layer 534 via network 510. In one embodiment, no dedicated UI server or client programs are needed. The communication with the backend 540 may include extracting, storing and updating data. The data may be transported to and from repositories 570, especially when the backend 540 implements a number of server nodes in separate computer system environments.

In one embodiment, users 505 generate services requests at UI client 524. UI components module 528 instantiates one or more appropriate graphical user interface (GUI) screens or controls in response to the user request. The behavior of the UI components is managed by controller 526. The controller 526 makes sure that all instantiated controls in the UI components 528 are initialized. The controller is also responsible for the execution of any configured operation triggered by events corresponding to the instantiated controls. In case where some of the operations involve execution of script segments, the controller 526 may trigger the execution of these scripts via scripts module 530. In one embodiment, scripts module 530 is a frontend scripting engine. Analytics module 532 may be used for frontend data processing when necessary.

In one embodiment, the backend 540 utilizes presentation layer 542 to connect to the Internet and/or to other public or private networks, and to provide access for the UI client sessions 524 to underlying business functions and data structures. For example, the presentation layer 542 may generate the UI object model underlying the UI controls instantiated in the UI components module 528 at the client systems 520. In one embodiment, presentation layer 542 may be part of the server runtime 544.

The server runtime 544 provides environment where one or more software applications 546 are executed. For example, the applications 546 may provide a number of business services for the users 505, where various operation requests related to the business services are created at client systems 520. The requests are translated to corresponding process tasks performed by the applications 546 executed in server runtime 544. Accordingly, one or more of the applications 546 could be used by one or more of the users 505 to alter the behavior of one or more other applications 546.

In one embodiment, the server runtime 544 includes backend controller 548 for one or more UI client sessions 524 to handle the requested UI components, e.g., when a UI client session 524 triggers an initialization of a UI component for the first time. The backend controller 548 may manage the collaboration between the requested UI components and one or more underlying objects. System services 550 in the server runtime 544 may be used to administer the characteristics of the server runtime 544, e.g., its engine parameters, the user access to one or more components, the processes execution, the communication with other runtime environments, like, external systems, databases, etc. In one embodiment, system services 550 may also provide deployment, setup and change management of software components.

Metadata repository 552 is generally the place where metadata about the computer programs deployed in the server system 540 are preserved, according to one embodiment. There are different kinds of metadata that could be maintained by the metadata repository 552. For example, the repository 552 keeps the description of the objects 556 underlying the applications 546. In one embodiment, metadata repository 552 keeps description of the available UI components 558 and the relationships between them as designed.

Repository engine 554 manages the metadata and the collaboration with the server runtime 544 at one hand, and with various external systems 565 at the other hand. The external systems 565 may render services and/or corresponding UI components to the backend 540 as defined in the metadata. The external systems 565 are available via external systems interfaces 560. In one embodiment, backend services adaptation 562 represents a layer that helps to adjust the designed UI or rendered UI components to a set of normalized objects available at the server system 540.

In a multi server system environment, e.g., in a cluster of more than one server system nodes 540, repository 570 may be used to persist different kinds of common data (e.g., data 575), including business data, metadata, programming code, etc. In one embodiment, one or more different repositories 570 may be assigned to different computer system environments defined in the computer system landscape 500.

In one embodiment, users 505 may design, create or change a program component, a data object or some other type of computer system artifact by manipulating UI components 528 associated with particular application or software tool. The UI components 528 may be available within GUI environment of the UI client 524. The manipulations of the UI components 528 may trigger execution of various system or application procedures in server runtime 544. Further, the manipulations of the UI components 528 may lead to changes in the metadata repository 552, e.g., changes in the definitions of the UI components 558, even changes in the descriptions of the objects 556, etc.

For example, by manipulating UI components 528 or by directly entering program code, a user 505 may create a programming component artifact in development computer system environment defined in the landscape 500. The created programing component could be a modification of an existing one, and the purpose of the modification could be to alter during runtime the behavior of the installed existing component. The modified component could be stored as artifact among other artifacts, e.g., code 580, in repository 570. Same or another user 505 may trigger the upload of the modified component in server runtime 544, e.g., into one or more corresponding applications 546. The behavior of the affected applications will change accordingly, when the execution of the functionalities associated with the modified component are requested.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

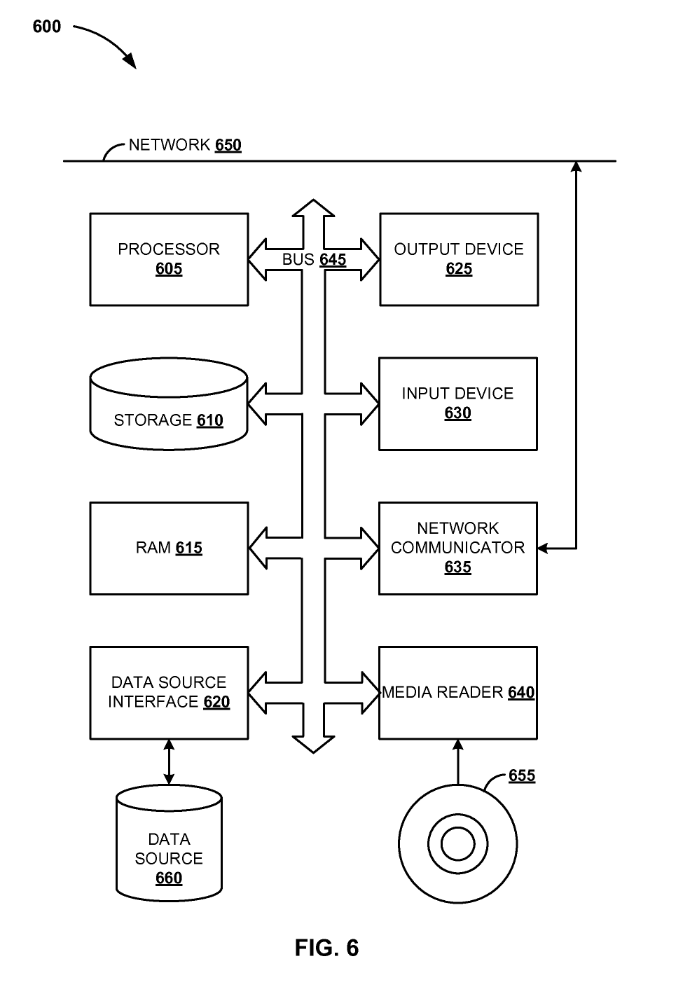

FIG. 6 is a block diagram of an exemplary computer system 600. The computer system 600 includes a processor 605 that executes software instructions or code stored on a computer readable storage medium 655 to perform the above-illustrated methods. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed via network 650. In some embodiments the data source 660 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the presented embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limiting to the precise forms disclosed. While specific embodiments and examples are described herein for illustrative purposes, various equivalent modifications are possible, as those skilled in the relevant art will recognize. These modifications can be made in light of the above detailed description. Rather, the scope of the specification is to be determined by the following claims, which are to be interpreted in accordance with established doctrines of claim construction.

The claims are amended as follows:

1. A computer system to alter behavior of applications during runtime, the computer system comprising:
memory to store computer instructions; and
a processor coupled to the memory to execute the stored instructions to:
read a modified application component from a resource provider;
scan a runtime environment to identify an original application component corresponding to the modified application component, wherein the original application component is loaded in the runtime environment to execute one or more applications;
submit the modified application component to the runtime environment to handle next invocation during the execution of at least one of the one or more applications; and
revert the runtime environment to the original application component to handle subsequent invocation during the execution of an application of the at least one of the one or more applications.

2. The system of claim 1, wherein reading the modified application component from the resource provider comprises:
parse an archived package of different application components to identify the modified application component.

3. The system of claim 1, wherein reading the modified application component from the resource provider comprises:
locate the modified application components in a file system as a separate file based on a received file path.

4. The system of claim 1, wherein identifying the original application component corresponding to the modified application component comprises:
identify one or more instances of the original application component loaded in the runtime environment, wherein the one or more instances of the original application component are associated with the one or more applications, and wherein an instance of the one or more instances of the original application component is associated with an application of the one or more applications.

5. The system of claim 4, wherein submitting the modified application component to the runtime environment comprises:
render, to a user interface, the one or more instances of the original application component and the associated one or more applications; and
in response to receiving a user selection of the at least one of the one or more applications, redefine at least one of the one or more instances of the original application component associated with the at least one of the one or more applications, based on the modified application component.

6. The system of claim 1, wherein reverting the runtime environment to the original application component comprises:
store a state of the original application component; and
submit the stored state of the original application component to the runtime environment.

7. A non-transitory computer-readable medium having instructions stored thereon, which when executed by a computer, cause the computer to perform operations comprising:
read a modified application component from a resource provider;
scan a runtime environment to identify an original application component corresponding to the modified application component, wherein the original application component is loaded in the runtime environment to execute one or more applications;
submit the modified application component to the runtime environment to handle next invocation during the execution of at least one of the one or more applications; and
revert the runtime environment to the original application component to handle subsequent invocation during the execution of an application of the at least one of the one or more applications.

8. The computer-readable medium of claim 7, wherein reading the modified application component from the resource provider comprises:
parsing an archived package of different application components to identify the modified application component.

9. The computer-readable medium of claim 7, wherein reading the modified application component from the resource provider comprises:
locating the modified application components in a file system as a separate file based on a received file path.

10. The computer-readable medium of claim 7, wherein identifying the original application component corresponding to the modified application component comprises:
identifying one or more instances of the original application component loaded in the runtime environment, wherein the one or more instances of the original application component are associated with a separate application of the one or more applications, and wherein an instance of the one or more instances of the original application component is associated with an application of the one or more applications.

11. The computer-readable medium of claim 10, wherein submitting the modified application component to the runtime environment comprises:
rendering, to a user interface, the one or more instances of the original application component and the associated one or more applications; and
in response to receiving a user selection of the at least one of the one or more applications, redefining at least one of the one or more instances of the original application component associated with the at least one of the one or more applications, based on the modified application component.

12. The computer-readable medium of claim 7, wherein reverting the runtime environment to the original application component comprises:
storing a state of the original application component; and
submitting the stored state of the original application component to the runtime environment.

13. The computer-readable medium of claim 12, wherein submitting the stored state of the original application component to the runtime environment comprises:
rendering, to a user interface, one or more instances of the modified application component and the at least one of the one or more applications, wherein the one or more instances of the modified application component are associated with the at least one of the one or more applications, and wherein an instance of the one or more instances of the modified application component is associated with the application of the at least one of the one or more applications; and
in response to receiving a user selection of the application of the at least one of the one or more applications, redefining the associated instance of the modified application component based on the stored state of the original application component.

14. A computer implemented method to alter behavior of applications during runtime, the method comprising:
reading a modified application component from a resource provider;
scanning a runtime environment to identify an original application component corresponding to the modified application component, wherein the original application component is loaded in the runtime environment to execute one or more applications;
submitting the modified application component to the runtime environment to handle next invocation during the execution of at least one of the one or more applications; and
reverting the runtime environment to the original application component to handle subsequent invocation during the execution of an application of the at least one of the one or more applications.

15. The method of claim 14, wherein reading the modified application component from the resource provider comprises:
parsing an archived package of different application components to identify the modified application component.

16. The method of claim 14, wherein reading the modified application component from the resource provider comprises:
locating the modified application components in a file system as a separate file based on a received file path.

17. The method of claim 14, wherein identifying the original application component corresponding to the modified application component comprises:
identifying one or more instances of the original application component loaded in the runtime environment, wherein the one or more instances of the original application component are associated with the one or more applications, and wherein an instance of the one or more instances of the original application component is associated with an application of the one or more applications.

18. The method of claim 17, wherein submitting the modified application component to the runtime environment comprises:
rendering, to a user interface, the one or more instances of the original application component and the associated one or more applications; and
in response to receiving a user selection of the at least one of the one or more applications, redefining at least one of the one or more instances of the original application component associated with the at least one of the one or more applications, based on the modified application component.

19. The method of claim 14, wherein reverting the runtime environment to the original application component comprises:
storing a state of the original application component; and
submitting the stored state of the original application component to the runtime environment.

20. The method of claim 19, wherein submitting the stored state of the original application component to the runtime environment comprises:
rendering, to a user interface, one or more instances of the modified application component and the at least one of the one or more applications, wherein the one or more instances of the modified application component are associated with the at least one of the one or more applications, and wherein an instance of the one or more instances of the modified application component is associated with the application of the at least one of the one or more applications; and
in response to receiving a user selection of the application of the at least one of the one or more applications, redefining the associated instance of the modified application component based on the stored state of the original application component.
